(19) United States
(12) Patent Application Publication
(10) Pub. No.: US 2026/0291292 A1
(43) Pub. Date: Sep. 24, 2026

(54) CONDITIONAL COMMUNICATION TIMES FOR ENERGY HARVESTING CAPABLE DEVICES

(71) Applicant: QUALCOMM Incorporated, San Diego, CA (US)

(72) Inventors: Alexandros MANOLAKOS, Athens (GR); Ahmed ELSHAFIE, San Diego, CA (US)

(21) Appl. No.: 19/478,385

(22) PCT Filed: Jun. 10, 2024
(86) PCT No.: PCT/US2024/033285

§ 371 Date: Oct. 24, 2025

(30) Foreign Application Priority Data
Jul. 4, 2023 (GR) 20230100541

(51) Int. Cl. H02J 50/80; H02J 50/00; H04W 52/02

(52) U.S. Cl. CPC H02J 50/80; H02J 50/001; H04W 52/0258

(57) ABSTRACT

Methods, systems, and devices for wireless communications are described. An energy harvesting (EH)-capable user equipment (UE) may indicate to the network a threshold delay period between communications involving the EH-capable UE. The network may schedule communications with and communicate with the EHcapable UE in accordance with the indicated threshold delay period. Accordingly, the EH-capable UE may resynchronize the internal clock of the EH-capable UE between communications based on synchronization signals received during the delay period and/or may harvest energy to recharge the internal energy storage of the EH-capable UE during the delay period. Thus, indicating a threshold delay period enables the EHcapable UE to avoid excess clock frequency drift and running out of power.

### CROSS REFERENCE

The present Application for Patent is a 371 national phase filing of International PCT Application No. PCT/US2024/033285 by MANOLAKOS et al., entitled “CONDITIONAL COMMUNICATION TIMES FOR ENERGY HARVESTING CAPABLE DEVICES,” filed Jun. 10, 2024, which claims priority to Greece Patent Application No. 20230100541 by MANOLAKOS et al., entitled “CONDITIONAL COMMUNICATION TIMES FOR ENERGY HARVESTING CAPABLE DEVICES,” filed Jul. 4, 2023, each of which is assigned to the assignee hereof, and each of which is expressly incorporated by reference herein.

### FIELD OF TECHNOLOGY

The following relates to wireless communications, including conditional communication times for energy harvesting (EH)-capable devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may include ambient internet of things (AIoT) devices, which may be energy harvesting (EH)-capable devices. EH-capable devices may be used to perform operations such as location tracking and identification. EH-capable devices may harvest energy from sources such as transmissions from other devices, ambient radio frequency energy, or solar energy. Passive EH-capable devices may not have their own power sources, but may receive power from transmissions by other devices. Semi-passive EH-capable devices may not generate signals, but have energy storage capability for signal processing or signal amplification. Active EH-capable devices include energy storage capability for signal generation and signal amplification. Active and semi-passive EH-capable devices include a clock to maintain timing with the network. Each reception or transmission may drain energy from the EH-capable device

### SUMMARY

The described techniques relate to improved methods, systems, devices, and apparatuses that support conditional communication times for energy harvesting (EH)-capable devices. For example, the described techniques provide for indication by an EH-capable user equipment (UE) of a threshold delay period between communications involving the EH-capable UE. The network may schedule communications with and communicate with the EH-capable UE in accordance with the indicated threshold delay period. Accordingly, the EH-capable UE may resynchronize the internal clock of the EH-capable UE between communications based on synchronization signals received during the delay period and/or may harvest energy to recharge the internal energy storage of the EH-capable UE during the delay period. Thus, indicating a threshold delay period enables the EH-capable UE to avoid excess clock frequency drift and/or running out of energy.

A method for wireless communications by an EH-capable UE is described. The method may include transmitting control information indicating a threshold delay period between communications involving the EH-capable UE, performing a first communication of data, and performing a second communication of data based on a time period between the first communication and the second communication satisfying the threshold delay period.

An EH-capable UE for wireless communications is described. The EH-capable UE may include one or more memories storing processor executable code, and one or more processors coupled with the one or more memories. The one or more processors may individually or collectively operable to execute the code to cause the EH-capable UE to transmit control information indicating a threshold delay period between communications involving the EH-capable UE, perform a first communication of data, and perform a second communication of data based on a time period between the first communication and the second communication satisfying the threshold delay period.

Another EH-capable UE for wireless communications is described. The EH-capable UE may include means for transmitting control information indicating a threshold delay period between communications involving the EH-capable UE, means for performing a first communication of data, and means for performing a second communication of data based on a time period between the first communication and the second communication satisfying the threshold delay period.

A non-transitory computer-readable medium storing code for wireless communications is described. The code may include instructions executable by a processor to transmit control information indicating a threshold delay period between communications involving the EH-capable UE, perform a first communication of data, and perform a second communication of data based on a time period between the first communication and the second communication satisfying the threshold delay period.

Some examples of the method, EH-capable UEs, and non-transitory computer-readable medium described herein may further include operations, features, means, or instructions for receiving a quantity of synchronization signals between performance of the first communication and the second communication, where the threshold delay period may be based on reception of a threshold quantity of synchronization signals, and where the quantity of synchronization signals satisfies the threshold quantity of synchronization signals.

Some examples of the method, EH-capable UEs, and non-transitory computer-readable medium described herein may further include operations, features, means, or instructions for identifying the threshold quantity of synchronization signals based on an operating bandwidth for the EH-capable UE, a signal type of the first communication, a signal type of the second communication, a transmission power of the first communication, a transmission power of the second communication, a device class of the EH-capable UE, or a combination thereof.

In some examples of the method, EH-capable UEs, and non-transitory computer-readable medium described herein, transmitting the control information indicating the threshold delay period may include operations, features, means, or instructions for transmitting an indication of a clock accuracy model for the EH-capable UE.

In some examples of the method, EH-capable UEs, and non-transitory computer-readable medium described herein, performing the first communication may include operations, features, means, or instructions for receiving the first communication, where performing the second communication includes one of receiving or transmitting the second communication.

Some examples of the method, EH-capable UEs, and non-transitory computer-readable medium described herein may further include operations, features, means, or instructions for receiving scheduling information for a set of synchronization signals, where the set of synchronization signals includes the quantity of synchronization signals, and where the threshold delay period may be based on the scheduling information.

In some examples of the method, EH-capable UEs, and non-transitory computer-readable medium described herein, transmitting the control information may include operations, features, means, or instructions for transmitting an indication of a threshold quantity of synchronization signals between the communications involving the EH-capable UE in addition to indicating the threshold delay period, where performance of the second communication may be based on reception of a quantity of synchronization signals between performance of the first communication and the second communication that satisfies the threshold quantity of synchronization signals.

In some examples of the method, EH-capable UEs, and non-transitory computer-readable medium described herein, performing the first communication may include operations, features, means, or instructions for transmitting the first communication, and where performing the second communication includes one of receiving or transmitting the second communication.

In some examples of the method, EH-capable UEs, and non-transitory computer-readable medium described herein, transmitting the control information indicating the threshold delay period may include operations, features, means, or instructions for transmitting an energy report for the EH-capable UE, an indication of a device class of the EH-capable UE, or a combination thereof.

A method for wireless communications by a network entity is described. The method may include receiving, from an EH-capable UE, control information indicating a threshold delay period between communications involving the EH-capable UE, performing, with the EH-capable UE, a first communication of data, and performing, with the EH-capable UE, a second communication of data based on a time period between the first communication and the second communication satisfying the threshold delay period.

A network entity for wireless communications is described. The network entity may include one or more memories storing processor executable code, and one or more processors coupled with the one or more memories. The one or more processors may individually or collectively operable to execute the code to cause the network entity to receive, from an EH-capable UE, control information indicating a threshold delay period between communications involving the EH-capable UE, perform, with the EH-capable UE, a first communication of data, and perform, with the EH-capable UE, a second communication of data based on a time period between the first communication and the second communication satisfying the threshold delay period.

Another network entity for wireless communications is described. The network entity may include means for receiving, from an EH-capable UE, control information indicating a threshold delay period between communications involving the EH-capable UE, means for performing, with the EH-capable UE, a first communication of data, and means for performing, with the EH-capable UE, a second communication of data based on a time period between the first communication and the second communication satisfying the threshold delay period.

A non-transitory computer-readable medium storing code for wireless communications is described. The code may include instructions executable by a processor to receive, from an EH-capable UE, control information indicating a threshold delay period between communications involving the EH-capable UE, perform, with the EH-capable UE, a first communication of data, and perform, with the EH-capable UE, a second communication of data based on a time period between the first communication and the second communication satisfying the threshold delay period.

Some examples of the method, network entities, and non-transitory computer-readable medium described herein may further include operations, features, means, or instructions for transmitting a quantity of synchronization signals between performance of the first communication and the second communication, where the threshold delay period may be based on a threshold quantity of synchronization signals, and where the quantity of synchronization signals satisfies the threshold quantity of synchronization signals.

In some examples of the method, network entities, and non-transitory computer-readable medium described herein, the threshold quantity of synchronization signals may be based on an operating bandwidth for the EH-capable UE, a signal type of the first communication, a signal type of the second communication, a transmission power of the first communication, a transmission power of the second communication, a device class of the EH-capable UE, or a combination thereof.

In some examples of the method, network entities, and non-transitory computer-readable medium described herein, receiving the control information indicating the threshold delay period may include operations, features, means, or instructions for receiving an indication of a clock accuracy model for the EH-capable UE.

In some examples of the method, network entities, and non-transitory computer-readable medium described herein, performing the first communication may include operations, features, means, or instructions for transmitting the first communication, and where performing the second communication includes one of receiving or transmitting the second communication.

Some examples of the method, network entities, and non-transitory computer-readable medium described herein may further include operations, features, means, or instructions for transmitting, to the EH-capable UE, scheduling information for a set of synchronization signals, where the set of synchronization signals includes the quantity of synchronization signals, and where the threshold delay period may be based on the scheduling information.

In some examples of the method, network entities, and non-transitory computer-readable medium described herein, receiving the control information may include operations, features, means, or instructions for receiving an indication of a threshold quantity of synchronization signals between the communications involving the EH-capable UE in addition to the threshold delay period, where performance of the second communication may be based on transmission of a quantity of synchronization signals between performance of the first communication and the second communication that satisfies the threshold quantity of synchronization signals.

In some examples of the method, network entities, and non-transitory computer-readable medium described herein, performing the first communication may include operations, features, means, or instructions for receiving the first communication, and where performing the second communication includes one of receiving or transmitting the second communication.

In some examples of the method, network entities, and non-transitory computer-readable medium described herein, receiving the control information indicating the threshold delay period may include operations, features, means, or instructions for receiving an energy report for the EH-capable UE, an indication of a device class of the EH-capable UE, or a combination thereof.

### BRIEF DESCRIPTION OF THE DRAWINGS

FIG. 1 shows an example of a wireless communications system that supports conditional communication times for energy harvesting (EH)-capable devices in accordance with one or more aspects of the present disclosure.

FIG. 2 shows an example of a wireless communications system that supports conditional communication times for EH-capable devices in accordance with one or more aspects of the present disclosure.

FIG. 3 shows an example of a timing diagram that supports conditional communication times for EH-capable devices in accordance with one or more aspects of the present disclosure.

FIG. 4 shows an example of a process flow that supports conditional communication times for EH-capable devices in accordance with one or more aspects of the present disclosure.

FIGS. 5 and 6 show block diagrams of devices that support conditional communication times for EH-capable devices in accordance with one or more aspects of the present disclosure.

FIG. 7 shows a block diagram of a communications manager that supports conditional communication times for EH-capable devices in accordance with one or more aspects of the present disclosure.

FIG. 8 shows a diagram of a system including a device that supports conditional communication times for EH-capable devices in accordance with one or more aspects of the present disclosure.

FIGS. 9 and 10 show block diagrams of devices that support conditional communication times for EH-capable devices in accordance with one or more aspects of the present disclosure.

FIG. 11 shows a block diagram of a communications manager that supports conditional communication times for EH-capable devices in accordance with one or more aspects of the present disclosure.

FIG. 12 shows a diagram of a system including a device that supports conditional communication times for EH-capable devices in accordance with one or more aspects of the present disclosure.

FIGS. 13 and 14 show flowcharts illustrating methods that support conditional communication times for EH-capable devices in accordance with one or more aspects of the present disclosure.

### DETAILED DESCRIPTION

Various aspects relate generally to wireless communication and more particularly to conditional communication times for energy harvesting (EH)-capable devices. Some aspects more specifically relate to performance by an EH-capable device of multiple communications based on a threshold delay period between the multiple communications. In some aspects, an EH-capable user equipment (UE) may indicate to the network a threshold delay period between communications involving the EH-capable UE. The threshold delay period may enable an EH-capable UE to resynchronize the internal clock of the EH-capable UE between communications and/or to harvest energy to recharge the internal energy storage of the EH-capable UE between communications. The threshold delay period may be based on the UE class (e.g., the type of ambient internet of things (A-IoT) device), the type of signals being communicated, and/or the operating bandwidth. The network may schedule communications with the EH-capable UE in accordance with the indicated threshold delay period for the EH-capable UE.

Particular aspects of the subject matter described in this disclosure can be implemented to realize one or more of the following potential advantages. By indicating a threshold delay period between communications involving the EH-capable UE, the network may schedule communications with the EH-capable UE such that the EH-capable UE may resynchronize the internal clock of the EH-capable UE between communications and/or may harvest energy to recharge the internal energy storage of the EH-capable UE between communications. As described herein, active and semi-passive EH-capable devices include an internal clock to maintain timing with the network. Transmission and reception of signals, via either active generation of a signal or via backscattering, increases temperature of the EH-capable device, which causes clock frequency drift and error. An EH-capable device may resynchronize the internal clock of the EH-capable device via monitoring for and receiving synchronization signals from the network. Further, each reception or transmission of a signal may drain energy from the EH-capable device. Thus, indicating a threshold delay period enables the EH-capable UE to avoid excess clock frequency drift and running out of power. In some cases, the EH-capable UE may indicate the UE class or type of the EH-capable UE, and the network may identify the threshold delay period based on the indicated UE class or type. Thus, the network may identify appropriate threshold delay periods based on the UE class or type. In some examples, the EH-capable UE may transmit an energy report to the network, and the network may identify the threshold delay period based on the energy report. Accordingly, the network may account for current energy conditions at the EH-capable UE when scheduling communications with the EH-capable UE.

Aspects of the disclosure are initially described in the context of wireless communications systems. Aspects of the disclosure are further illustrated by and described with reference to timing diagrams, process flows, apparatus diagrams, system diagrams, and flowcharts that relate to conditional communication times for EH-capable devices.

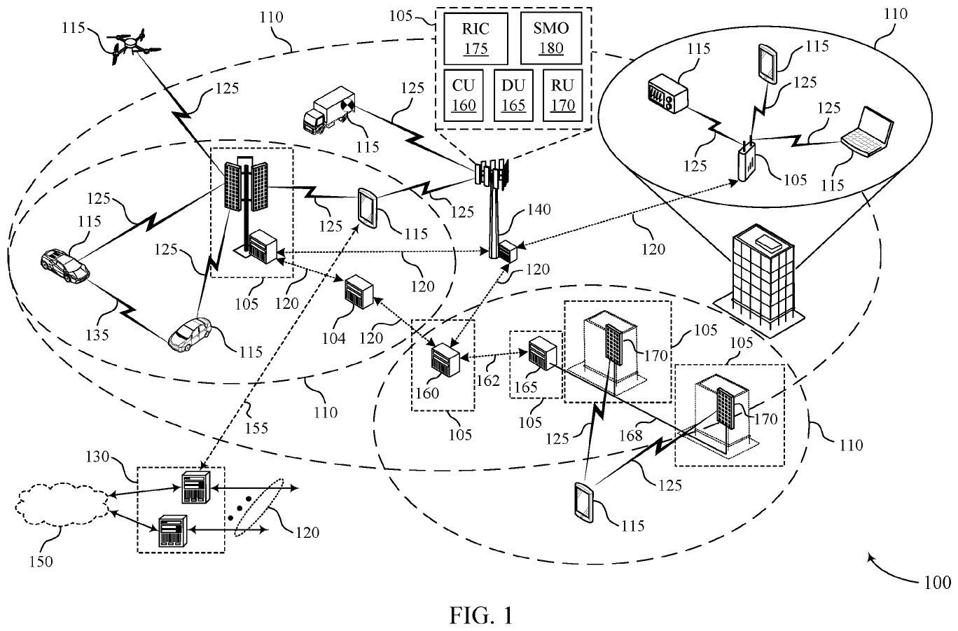

FIG. 1 shows an example of a wireless communications system 100 that supports conditional communication times for EH-capable devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support conditional communication times for EH-capable devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Some UEs 115 may be reduced capability (RedCap) UEs 115 or enhanced RedCap (eRedCap) UEs 115. An eRedCap UE 115 may have a restricted baseband (BB) capability of processing a physical downlink shared channel (PDSCH) of up to 25 physical resource blocks (PRBs) for a 15 kilohertz (KHz) subcarrier spacing (SCS) or 11 PRBs for a 30 kHz SCS. The timeline requirement for PDSCH processing for an eRedCap UE 115 may be kept the same for a PDSCH with less than 25 PRBs for a 15 kHz SCS or 11 PRBs for a 30 kHz SCS. For a random access response (RAR) PDSCH message of a 4 step random access procedure (RACH), the RAR PDSCH (e.g., msg 2 of the 4 step RACH) for the eRedCap UE 115 may be scheduled with more than 25 PRBs for a 15 kHz SCS or 11 PRBs for a 30 kHz SCS for coexistence purposes. In such examples, the PDSCH processing timeline requirements for the eRedCap UE 115 may be relaxed. For example, the time between the reception of msg 2 of a 4 step RACH (the RAR PDSCH message) and transmission of msg3 of the RACH by the eRedCap UE 115 may be increased by X milliseconds, where X=0 if the quantity of PRBs for the msg2 PDSCH is not larger than 25 PRBs for a 15 kHz SCS or 11 PRBs for a 30 kHz SCS, and X>0 if the quantity of PRBs for the msg2 PDSCH is larger than 25 PRBs for a 15 kHz SCS or 11 PRBs for a 30 kHz SCS.

In some aspects, the wireless communications system 100 may include AIoT devices, which may be EH-capable devices. EH-capable devices may be used to perform operations such as location tracking and identification. EH-capable devices may harvest energy from sources such as transmissions from other devices, ambient radio frequency energy, or solar. Passive EH-capable devices may not have their own power sources, but may receive power from transmissions by other devices. Semi-passive EH-capable devices may not generate signals, but have energy storage capability for signal processing or signal amplification (e.g., a low noise amplifier (LNA) or a power amplifier (PA)). Active EH-capable devices include energy storage capability for signal generation and signal amplification. Active and semi-passive EH-capable devices include an internal clock to maintain timing with the network. To optimize the use of energy, semi-passive and active EH-capable devices may monitor signals in a duty cycled manner. Transmission of signals, via either active generation of a signal or via backscattering, increases temperature of the EH-capable device, which causes clock frequency drift and error. After a transmission, an EH-capable device, especially lower power devices, may cool down and adjust timing or synchronization before another transmission. For example, an EH-capable device may resynchronize the internal clock via monitoring for synchronization signals from the network. Each reception or transmission may drain energy from the EH-capable device. After transmission or reception of a signal, an EH-capable device may take time to re-charge before transmission or reception of another signal (and the time to re-charge may depend on the charging and/or discharge rate).

An EH-capable UE 115 may indicate to the network (e.g., a serving network entity 105) a threshold delay period between communications involving the EH-capable UE 115. The network may schedule communications with and communicate with the EH-capable UE 115 in accordance with the indicated threshold delay period. Accordingly, the EH-capable UE 115 may resynchronize the internal clock of the EH-capable UE 115 between communications based on synchronization signals received during the delay period and/or may harvest energy to recharge the internal energy storage of the EH-capable UE 115 during the delay period. Thus, indicating a threshold delay period enables the EH-capable UE 115 to avoid excess clock frequency drift and running out of power. The threshold delay period may be based on the UE class (e.g., the type of AIoT device), the type of signals being communicated, and/or the operating bandwidth. In some cases, the EH-capable UE 115 may indicate the UE class, and the network entity 105 may identify the threshold delay period based on the indicated UE class. The network entity 105 may schedule communications with the EH-capable UE 115 based on the identified threshold delay period. In some examples, the EH-capable UE 115 may transmit an energy report to the network entity 105, and the network entity 105 may identify the threshold delay period based on the energy report. In some examples, the EH-capable UE 115 may indicate the threshold delay period and/or a threshold quantity of synchronization signals between communications to the network entity 105 (e.g., in layer 1, 2, or 3 signaling), and the EH-capable UE 115 and the network entity 105 may communicate according to the threshold delay period.

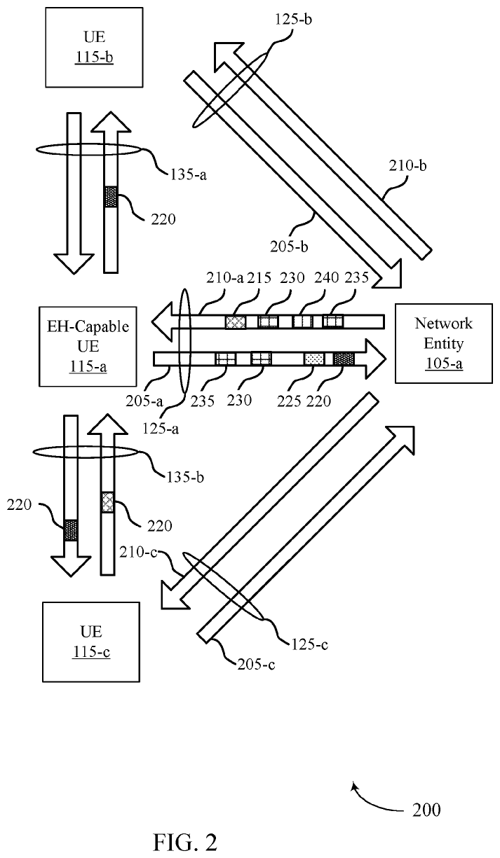

FIG. 2 shows an example of a wireless communications system 200 that supports conditional communication times for EH-capable devices in accordance with one or more aspects of the present disclosure. The wireless communications system 200 may implement aspects of or may be implemented by aspects of the wireless communications system 100. For example, the wireless communications system 200 includes an EH-capable UE 115-a, which may be an example of an EH-capable UE 115 as described herein. The wireless communications system 200 also includes a UE 115-b and a UE 115-c, which may be examples of a UE 115 described herein. The wireless communications system 200 also includes a network entity 105-a, which may be an example of a network entity 105 as described herein.

In some examples, the EH-capable UE 115-a may communicate with the network entity 105-a using a communication link 125-a. The communication link 125-a may be an example of an NR or LTE link between the EH-capable UE 115-a and the network entity 105-a. In some examples, the communication link 125-a may include a bi-directional link that enable both uplink and downlink communications. For example, the EH-capable UE 115-a may transmit uplink signals 205-a (e.g., uplink transmissions), such as uplink control signals or uplink data signals, to the network entity 105-a using the communication link 125-a and the network entity 105-a may transmit downlink signals 210-a (e.g., downlink transmissions), such as downlink control signals or downlink data signals, to the EH-capable UE 115-a using the communication link 125-a.

The UE 115-b may communicate with the network entity 105-a using a communication link 125-b, and the UE 115-c may communicate with the network entity 105-a using a communication link 125-c. The communication link 125-b may be an example of an NR or LTE link between the UE 115-b and the network entity 105-a. The communication link 125-c may be an example of an NR or LTE link between the UE 115-c and the network entity 105-a. The communication link 125-b and the communication link 125-c may include bi-directional links that enable both uplink and downlink communications. For example, the UE 115-b may transmit uplink signals 205-b (e.g., uplink transmissions), such as uplink control signals or uplink data signals, to the network entity 105-a using the communication link 125-b and the network entity 105-a may transmit downlink signals 210-b (e.g., downlink transmissions), such as downlink control signals or downlink data signals, to the UE 115-b using the communication link 125-b. The UE 115-c may transmit uplink signals 205-c (e.g., uplink transmissions), such as uplink control signals or uplink data signals, to the network entity 105-a using the communication link 125-c and the network entity 105-a may transmit downlink signals 210-c (e.g., downlink transmissions), such as downlink control signals or downlink data signals, to the UE 115-c using the communication link 125-c.

In some examples, the EH-capable UE 115-a may communicate with the UE 115-b using a communication link 135-a, and the EH-capable UE 115-a may communicate with the UE 115-c using a communication link 135-b, which may be examples of a communication link 135 as described herein. For example, the communication link 135-a and the communication link 135-b may be sidelink communication links and may support bidirectional communications between the EH-capable UE 115-a and the UE 115-b and the UE 115-c, respectively.

In some examples, the EH-capable UE 115-a may be capable of performing backscattering. For example, the EH-capable UE 115-a may be an AIoT device or a radio frequency identification (RFID) tag which in response to an interrogating signal 215 may emit a backscatter response 220.

In some examples, the wireless communications system 200 may implement monostatic AIoT processing. In monostatic processing, the transmitter of the interrogating signal 215 and receiver of the backscatter response 220 are collocated (e.g., monostatic processing may demand a full duplex capable reader device). For example, the network entity 105-a may be a reader device which transmits an interrogating signal 215. The network entity 105-a may also receive backscatter response 220 to the interrogating signal 215. In some examples, another UE 115, such as the UE 115-b or the UE 115-c may be a monostatic reader device.

In some examples, the wireless communications system 200 may implement bistatic AIoT processing. In bistatic processing, the transmitter of the interrogating signal 215 and receiver of the backscatter response 220 are non-collocated. For example, the network entity 105-a may transmit an interrogating signal 215, and the UE 115-b may be the receiver device which receives the backscatter response 220. In some examples, the network entity 105-a may communicate scheduling information to the UE 115-b which schedules a monitoring occasion for reception of the backscatter response 220. In some examples, bistatic processing may be performed by two UEs 115. For example, the UE 115-c may transmit the interrogating signal 215 and the UE 115-b may receive the backscatter response 220. For example, the UE 115-b and the UE 115-b may be scheduled by the network entity 105-a with corresponding transmission and monitoring occasions for transmission of the interrogating signal 215 and reception of the backscatter response 220, or the UE 115-b and the UE 115-b may negotiate resources for transmission of the interrogating signal 215 and reception of the backscatter response 220.

In some examples, the wireless communications system 200 may implement multistatic AIoT processing. In multistatic processing, multiple devices (e.g., the UE 115-b, the UE 115-c, and/or the network entity 105-a) may receive the backscatter response 220 to the interrogating signal 215. Multistatic processing may be monostatic or bistatic based. For example, in monostatic based multistatic processing, the transmitter of the interrogating signal (e.g., the network entity 105-a) may also receive the backscatter response 220. In bistatic processing, the transmitter of the interrogating signal (e.g., the network entity 105-a) may not receive the backscatter response 220. In some examples, multistatic processing may involve transmission of the interrogating signal from multiple devices (e.g., the network entity 105-a and the UE 115-c may both transmit the interrogating signal 215). In some examples, the network entity 105-a may communicate scheduling information for the transmission of the interrogating signal 215 and/or reception of the backscatter response 220 with the UE 115-b and the UE 115-c.

As described herein, transmission of signals, via either active generation of a signal or via backscattering (e.g., emission of the backscatter response 220), increases the temperature of the EH-capable UE 115-a which causes internal clock frequency drift and error. The EH-capable UE 115-a may monitor for and receive synchronization signals 240 (e.g., such as synchronization signal blocks (SSBs)) transmitted by the network entity 105-a in order to synchronize the internal clock of the EH-capable UE 115-a with the network timing. Each reception or transmission may drain energy from the EH-capable UE 115-a. After transmission or reception of a signal, the EH-capable UE 115-a may take time to re-charge before transmission or reception of another signal.

The EH-capable UE 115-a may transmit control information 225 to the network entity 105-a that indicates a threshold delay period between communications involving the EH-capable UE 115-a. The threshold delay period between communications (e.g., a first communication 230 and a second communication 235) involving the EH-capable UE 115-a may allow for the EH-capable UE 115-a to receive synchronization signals 240 in order to synchronize the internal clock of the EH-capable UE 115-a with the network timing and/or to recharge the internal energy storage of the EH-capable UE 115-a.

In some examples, the first communication 230 may be a reception of a signal by the EH-capable UE 115-a. In some examples, after each reception of a signal, the EH-capable UE 115-a may be expected to monitor for a threshold quantity of synchronization signals 240 (e.g., a quantity X) before being able to receive another signal. In some examples, the quantity X may depend on the clock accuracy of the EH-capable UE 115-a. In some examples, the quantity X may be a function of the allocation of the received signals (e.g., the bandwidths of the first communication 230 and/or the second communication 235), the types of received signals (e.g., whether the first communication 230 and/or the second communication 235 are reference signals such as SSBs, control signals such as downlink control information (DCI), or information signals such as PDSCH), and/or the device class or type of the EH-capable UE 115-a. The clock accuracy of the EH-capable UE 115-a may be a capability of the EH-capable UE 115-a or may depend on the device class or type of the EH-capable UE 115-a. In some examples, clock accuracy information for the EH-capable UE 115-a may be indicated by the EH-capable UE 115-a to the network entity 105-a, for example, in msg1 or msg3 of a RACH procedure, or some other registration message. For example, information regarding the clock accuracy of the EH-capable UE 115-a indicated to the network entity 105-a may include initial clock accuracy values (e.g., initial clock frequency drift and maximum clock frequency error) or per certain temperature values (e.g., reference temperatures), and if the EH-capable UE 115-a changes temperature, the EH-capable UE 115-a may report the changed temperature to the network entity 105-a (e.g., using layer 1, 2, or 3 signaling). In some examples, the EH-capable UE 115-a may identify and report (e.g., using layer 1, 2, or 3 signaling) the changed clock parameters based on the changed temperature. In some examples, the changed temperature indication or the changed clock parameters indication may be multiplexed with layer 1, 2, or 3 signaling such as a CSI report, a buffer status report (BSR), a power headroom (PHR) report, a scheduling request (SR), or a HARQ-ACK. In some examples, the EH-capable UE 115-a may report a clock accuracy model to the network entity 105-a based on temperature (e.g., clock accuracy quantities per temperature), then the EH-capable UE 115-a may report temperature changes to the network entity 105-a.

In some examples, the threshold delay period may depend on a threshold quantity of synchronization signals. For example, the EH-capable UE 115-a may receive a quantity X synchronization signals 240 after reception of the first communication 230 and before reception of the second communication 235. For example, the EH-capable UE 115-a may indicate in the control information 225 that the EH-capable UE 115-a should not receive two communications (e.g., the first communication 230 and the second communication 235) within a window of Z time, where Z may depend on the amount of time to receive X synchronization signals 240. The synchronization signals 240 may be low power synchronization signals with long sequences.

In some examples, the first communication 230 may be a reception of a signal by the EH-capable UE 115-a. After each reception (e.g., after reception of the first communication 230), the EH-capable UE 115-a may be expected to monitor for and receive a quantity Y synchronization signals 240 before transmission of a signal (e.g., prior to transmission of the second communication 235). Accordingly, the threshold delay period between reception of a signal and transmission of a signal may depend on the time to receive the quantity Y synchronization signals 240. The quantity Y synchronization signals 240 may depend on the internal clock accuracy of the EH-capable UE 115-a. In some examples, the quantity Y synchronization signals 240 may be a function of the allocation of the received signal (e.g., the bandwidth of the first communication 230), the type of transmitted signal (e.g., a physical uplink shared channel (PUSCH) or sounding reference signal (SRS)), and/or the device class or type of the EH-capable UE 115-a.

In some examples, the first communication 230 may be a transmission of a signal by the EH-capable UE 115-a. In some examples, after each transmission (e.g., after transmission of the first communication 230), the EH-capable UE 115-a may be expected to monitor a quantity G time units (e.g., slots, subslots, symbols, milliseconds, or any bundle of symbols or slots) before reception or transmission of a subsequent communication (e.g., before transmission or reception of the second communication 235). The quantity of G time units may depend on the internal clock accuracy of the EH-capable UE 115-a. In some examples, the quantity of G time units may be a function of the allocation of the received signal (e.g., the bandwidth of the second communication 235), the type of signal of the first communication 230 (e.g., a physical uplink shared channel (PUSCH) or sounding reference signal (SRS)), the transmission power of the first communication 230 and/or the device class or type of the EH-capable UE 115-a.

In some examples, the EH-capable UE 115-a may indicate, in the control information 225, the delta time (e.g., as an average, maximum, or cumulative distribution function (CDF) for cooling down or adjusting the internal clock of the EH-capable UE 115-a as well as the number of synchronization signals 240 for synchronizing the internal clock of the EH-capable UE 115-a between communications involving the EH-capable UE 115-a or the time after a synchronization signal 240 such that the internal clock sufficiently accurate to receive or transmit a communication.

In some examples, the network entity 105-a may transmit scheduling information to the EH-capable UE 115-a that schedules a set of synchronization signals 240. In such examples, the threshold delay period indicated in the control information 225 may depend on the time to receive a demanded quantity of the scheduled synchronization signals 240. In some examples, synchronization signals 240 may have a relation or association with transmission or reception of signals. For example, the EH-capable UE 115-a may receive an allocation for a communication resource (e.g., a PUSCH, a PDSCH, a DCI, an SRS), with certain conditions such as a quantity of synchronization signal blocks/sets/resources Y allocated at times t1, t2, t3 from the allocation of the communications resource. In some examples, the conditions may be pre-configured (e.g., via layer 1, 2, or 3 signaling).

In some examples, the control information 225 may include an energy report for the EH-capable UE 115-a, and the network entity 105-a may identify a threshold delay period for the EH-capable UE 115-a based on the energy report. In some examples, the network entity 105-a may identify the threshold delay period based on temperature and/or clock reports received from the EH-capable UE 115-a in the control information 225 (e.g., before the first communication 230). In some examples, the network entity 105-a may identify the threshold delay period based on a clock accuracy and/or clock drift report received from the EH-capable UE 115-a in the control information 225 (e.g., before the first communication 230) and/or based on configured tables or mapping functions that may be indicated in control information or may be pre-defined based on the device class or type of the EH-capable UE 115-a. The EH-capable UE 115-a and the network entity 105-a may identify different threshold delay periods for different types of signals and/or different energy, clock, and/or temperature conditions at the EH-capable UE 115-a.

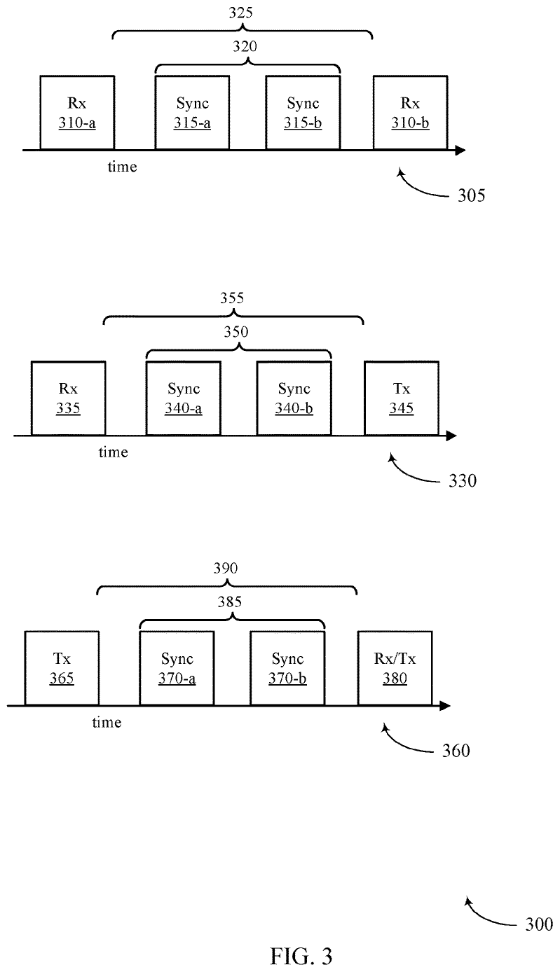

FIG. 3 shows an example of a timing diagram 300 that supports conditional communication times for EH-capable devices in accordance with one or more aspects of the present disclosure. The timing diagram may implement aspects of or may be implemented by aspects of the wireless communications system 100 or the wireless communications system 200.

A first example 305 shows a scenario where an EH-capable UE 115 expects a threshold delay period 325 between reception of a first communication 310-a and reception of a second communication 310-b. As described herein, the threshold delay period 325 may depend on a period of time 320 to receive a quantity of synchronization signals 315 (e.g., two synchronization signals, a first synchronization signal 315-a and a second synchronization signal 315-b). The EH-capable UE 115 may use the synchronization signals 315 to synchronize the internal clock of the EH-capable UE 115, which may suffer frequency drift after reception of each communication 310, with the network timing.

A second example 330 shows a scenario where an EH-capable UE 115 expects a threshold delay period 355 between reception of a first communication 335 and transmission of a second communication 345. As described herein, the threshold delay period 355 may depend on a period of time 350 to receive a quantity of synchronization signals 340 (e.g., two synchronization signals, a first synchronization signal 340-a and a second synchronization signal 340-b). The EH-capable UE 115 may use the synchronization signals 340 to synchronize the internal clock of the EH-capable UE 115, which may suffer frequency drift after reception of the first communication 335, with the network timing.

A third example 360 shows a scenario where an EH-capable UE 115 expects a threshold delay period 390 between transmission of a first communication 365 and transmission or reception of a second communication 380. As described herein, the threshold delay period 390 may depend on a period of time 385 to receive a quantity of synchronization signals 370 (e.g., two synchronization signals, a first synchronization signal 370-a and a second synchronization signal 370-b). The EH-capable UE 115 may use the synchronization signals 370 to synchronize the internal clock of the EH-capable UE 115, which may suffer frequency drift after transmission of the first communication 365, with the network timing.

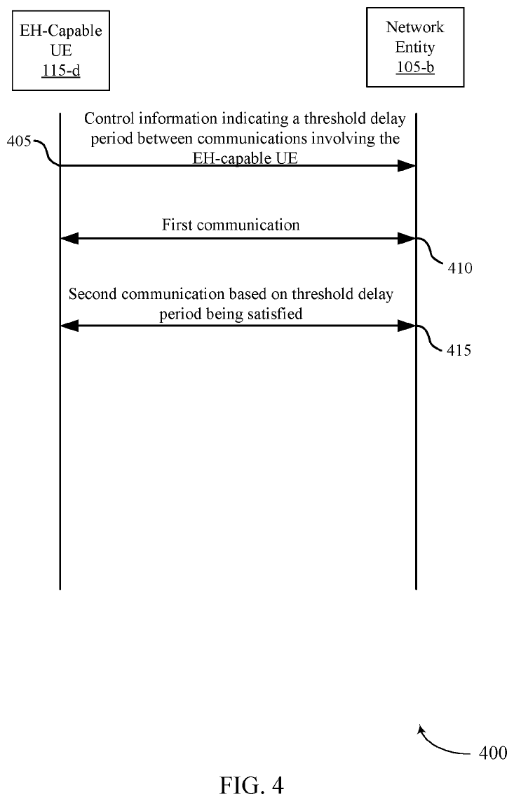

FIG. 4 shows an example of a process flow 400 that supports conditional communication times for EH-capable devices in accordance with one or more aspects of the present disclosure. The process flow 400 may include an EH-capable UE 115-d, which may be an example of a UE 115 as described herein. The process flow 400 may also include a network entity 105-b, which may be an example of network entity 105, as described herein. In the following description of the process flow 400, the operations between the network entity 105-b and the EH-capable UE 115-d may be transmitted in a different order than the example order shown, or the operations performed by between the network entity 105-b and the EH-capable UE 115-d may be performed in different orders or at different times. Some operations may also be omitted from the process flow 400, and other operations may be added to the process flow 400.

At 405, the EH-capable UE 115-d may transmit, to the network entity 105-b, control information indicating a threshold delay period between communications involving the EH-capable UE 115-d.

At 410, the EH-capable UE 115-d may perform a first communication of data with the network entity 105-b. At 415, the EH-capable UE 115-d may perform a second communication of data with the network entity 105-b based on a time period between the first communication and the second communication satisfying the threshold delay period.

In some examples, the EH-capable UE 115-d may receive a quantity of synchronization signals from the network entity 105-b between performance of the first communication at 410 and the second communication at 415, the threshold delay period is based on reception of a threshold quantity of synchronization signals, and the quantity of synchronization signals satisfies the threshold quantity of synchronization signals. In some examples, the EH-capable UE 115-d may identify the threshold quantity of synchronization signals based on an operating bandwidth for the EH-capable UE 115-d, a signal type of the first communication, a signal type of the second communication, a transmission power of the first communication, a transmission power of the second communication, a device class of the EH-capable UE 115-d, or a combination thereof. In some examples, at 405, the EH-capable UE 115-d may transmit an indication of a clock accuracy model for the EH-capable UE 115-d, which the network entity 105-b may use to identify the threshold delay period. In some examples, the network entity 105-b may transmit, to the EH-capable UE, scheduling information for a set of synchronization signals, where the set of synchronization signals includes the quantity of synchronization signals, and the threshold delay period is based on the scheduling information.

In some examples, performing the first communication involves receiving the communication of data at the EH-capable UE 115-d and performing the second communication involves receiving or transmitting the communication of data at the EH-capable UE 115-d. In some examples, performing the first communication involves transmitting the communication of data at the EH-capable UE 115-d and performing the second communication involves receiving or transmitting the communication of data at the EH-capable UE 115-d.

In some examples, at 405, the EH-capable UE 115-d may transmit an indication of a threshold quantity of synchronization signals between the communications involving the EH-capable UE in addition to indicating the threshold delay period, and performance of the second communication at 415 is based on reception of a quantity of synchronization signals between performance of the first communication at 410 and the second communication at 415 that satisfies the threshold quantity of synchronization signals.

In some examples, at 405, the EH-capable UE 115-d may transmit an energy report for the EH-capable UE 115-d, an indication of a device class of the EH-capable UE 115-d, or a combination thereof. The network entity 105-b may identify the threshold delay period based on the energy report and/or the device class of the EH-capable UE 115-d.

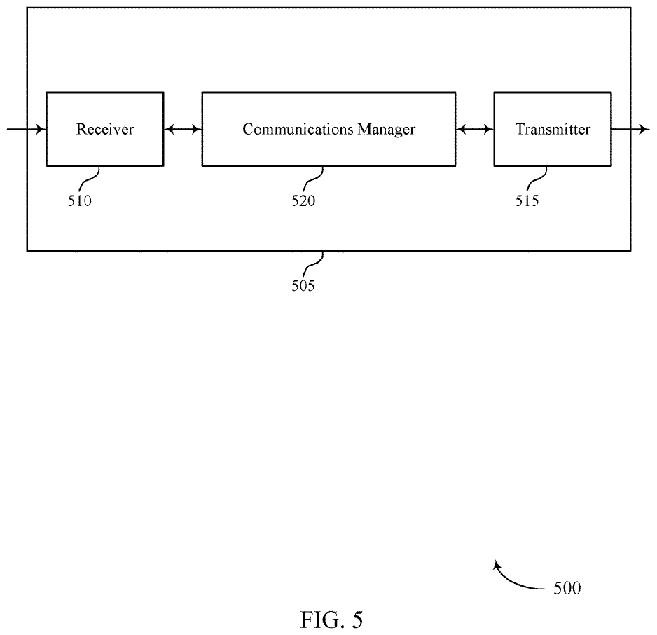

FIG. 5 shows a block diagram 500 of a device 505 that supports conditional communication times for EH-capable devices in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to conditional communication times for EH-capable devices).

Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to conditional communication times for EH-capable devices). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of conditional communication times for EH-capable devices as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting control information indicating a threshold delay period between communications involving the EH-capable UE. The communications manager 520 is capable of, configured to, or operable to support a means for performing a first communication of data. The communications manager 520 is capable of, configured to, or operable to support a means for performing a second communication of data based on a time period between the first communication and the second communication satisfying the threshold delay period.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and more efficient utilization of communication resources.

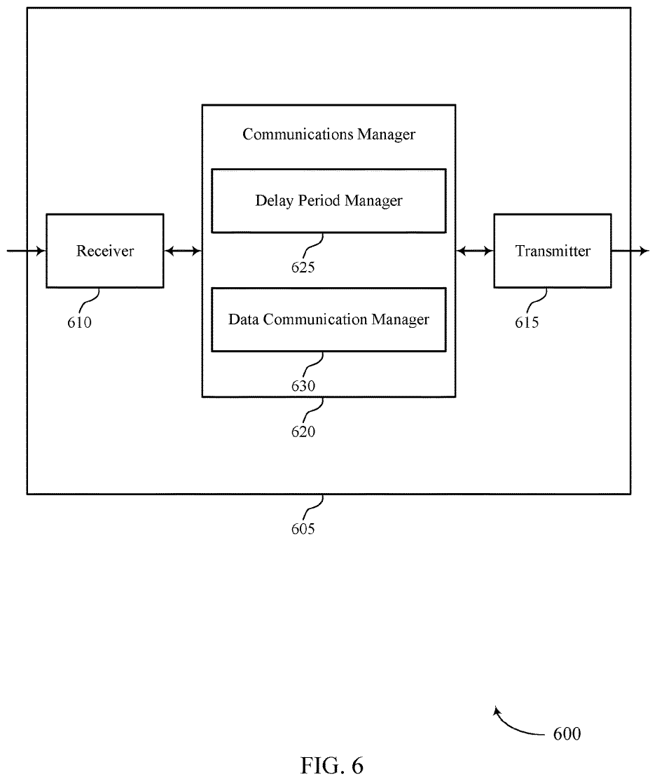

FIG. 6 shows a block diagram 600 of a device 605 that supports conditional communication times for EH-capable devices in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to conditional communication times for EH-capable devices).

Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to conditional communication times for EH-capable devices). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of conditional communication times for EH-capable devices as described herein. For example, the communications manager 620 may include a delay period manager 625 a data communication manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The delay period manager 625 is capable of, configured to, or operable to support a means for transmitting control information indicating a threshold delay period between communications involving the EH-capable UE. The data communication manager 630 is capable of, configured to, or operable to support a means for performing a first communication of data. The data communication manager 630 is capable of, configured to, or operable to support a means for performing a second communication of data based on a time period between the first communication and the second communication satisfying the threshold delay period.

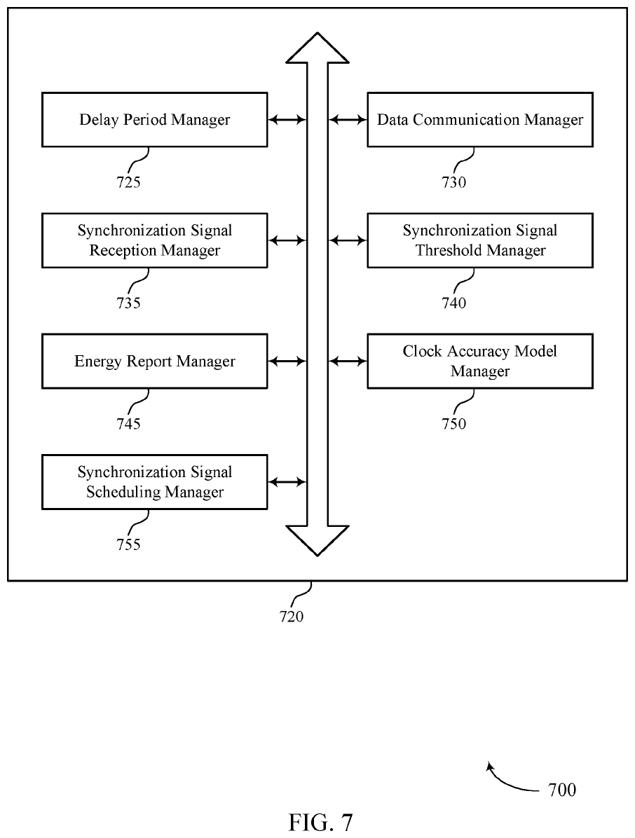

FIG. 7 shows a block diagram 700 of a communications manager 720 that supports conditional communication times for EH-capable devices in accordance with one or more aspects of the present disclosure. The communications manager 720 may be an example of aspects of a communications manager 520, a communications manager 620, or both, as described herein. The communications manager 720, or various components thereof, may be an example of means for performing various aspects of conditional communication times for EH-capable devices as described herein. For example, the communications manager 720 may include a delay period manager 725, a data communication manager 730, a synchronization signal reception manager 735, a synchronization signal threshold manager 740, an energy report manager 745, a clock accuracy model manager 750, a synchronization signal scheduling manager 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The delay period manager 725 is capable of, configured to, or operable to support a means for transmitting control information indicating a threshold delay period between communications involving the EH-capable UE. The data communication manager 730 is capable of, configured to, or operable to support a means for performing a first communication of data. In some examples, the data communication manager 730 is capable of, configured to, or operable to support a means for performing a second communication of data based on a time period between the first communication and the second communication satisfying the threshold delay period.

In some examples, the synchronization signal reception manager 735 is capable of, configured to, or operable to support a means for receiving a quantity of synchronization signals between performance of the first communication and the second communication, where the threshold delay period is based on reception of a threshold quantity of synchronization signals, and where the quantity of synchronization signals satisfies the threshold quantity of synchronization signals.

In some examples, the synchronization signal threshold manager 740 is capable of, configured to, or operable to support a means for identifying the threshold quantity of synchronization signals based on an operating bandwidth for the EH-capable UE, a signal type of the first communication, a signal type of the second communication, a transmission power of the first communication, a transmission power of the second communication, a device class of the EH-capable UE, or a combination thereof.

In some examples, to support transmitting the control information indicating the threshold delay period, the clock accuracy model manager 750 is capable of, configured to, or operable to support a means for transmitting an indication of a clock accuracy model for the EH-capable UE.

In some examples, to support performing the first communication, the data communication manager 730 is capable of, configured to, or operable to support a means for receiving the first communication, where performing the second communication includes one of receiving or transmitting the second communication.

In some examples, the synchronization signal scheduling manager 755 is capable of, configured to, or operable to support a means for receiving scheduling information for a set of synchronization signals, where the set of synchronization signals includes the quantity of synchronization signals, and where the threshold delay period is based on the scheduling information.

In some examples, to support transmitting the control information, the synchronization signal threshold manager 740 is capable of, configured to, or operable to support a means for transmitting an indication of a threshold quantity of synchronization signals between the communications involving the EH-capable UE in addition to indicating the threshold delay period, where performance of the second communication is based on reception of a quantity of synchronization signals between performance of the first communication and the second communication that satisfies the threshold quantity of synchronization signals.

In some examples, to support performing the first communication, the data communication manager 730 is capable of, configured to, or operable to support a means for transmitting the first communication, and where performing the second communication includes one of receiving or transmitting the second communication.

In some examples, to support transmitting the control information indicating the threshold delay period, the energy report manager 745 is capable of, configured to, or operable to support a means for transmitting an energy report for the EH-capable UE, an indication of a device class of the EH-capable UE, or a combination thereof.

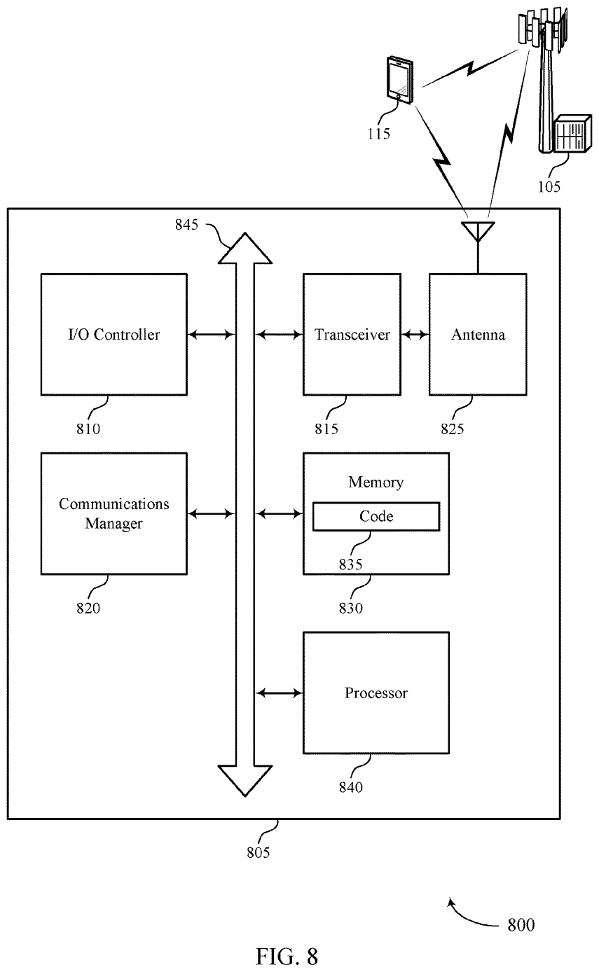

FIG. 8 shows a diagram of a system 800 including a device 805 that supports conditional communication times for EH-capable devices in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting conditional communication times for EH-capable devices). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein.

The communications manager 820 may support wireless communications in accordance with examples as disclosed herein. For example, the communications manager 820 is capable of, configured to, or operable to support a means for transmitting control information indicating a threshold delay period between communications involving the EH-capable UE. The communications manager 820 is capable of, configured to, or operable to support a means for performing a first communication of data. The communications manager 820 is capable of, configured to, or operable to support a means for performing a second communication of data based on a time period between the first communication and the second communication satisfying the threshold delay period.

By including or configuring the communications manager 820 in accordance with examples as described herein, the device 805 may support techniques for improved communication reliability, reduced power consumption, more efficient utilization of communication resources, improved coordination between devices, and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of conditional communication times for EH-capable devices as described herein, or the at least one processor 840 and the at least one memory 830 may be otherwise configured to, individually or collectively, perform or support such operations.

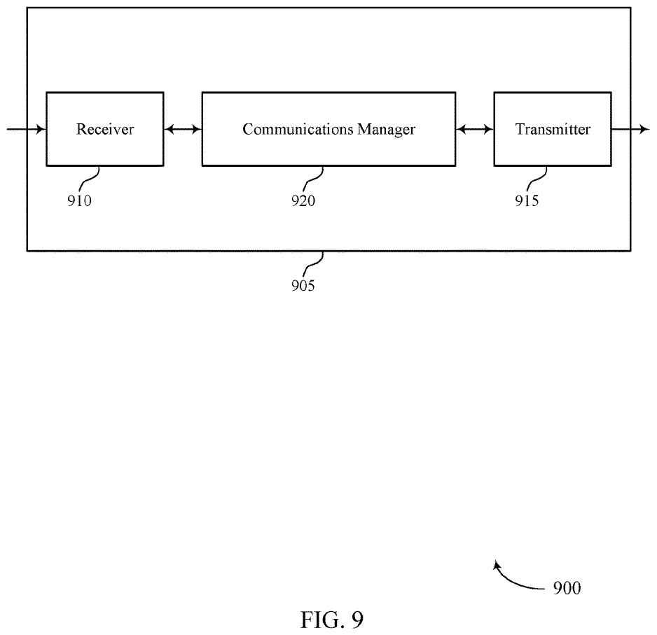

FIG. 9 shows a block diagram 900 of a device 905 that supports conditional communication times for EH-capable devices in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques.

Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas.

Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of conditional communication times for EH-capable devices as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving, from an EH-capable UE, control information indicating a threshold delay period between communications involving the EH-capable UE. The communications manager 920 is capable of, configured to, or operable to support a means for performing, with the EH-capable UE, a first communication of data. The communications manager 920 is capable of, configured to, or operable to support a means for performing, with the EH-capable UE, a second communication of data based on a time period between the first communication and the second communication satisfying the threshold delay period.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption and more efficient utilization of communication resources.

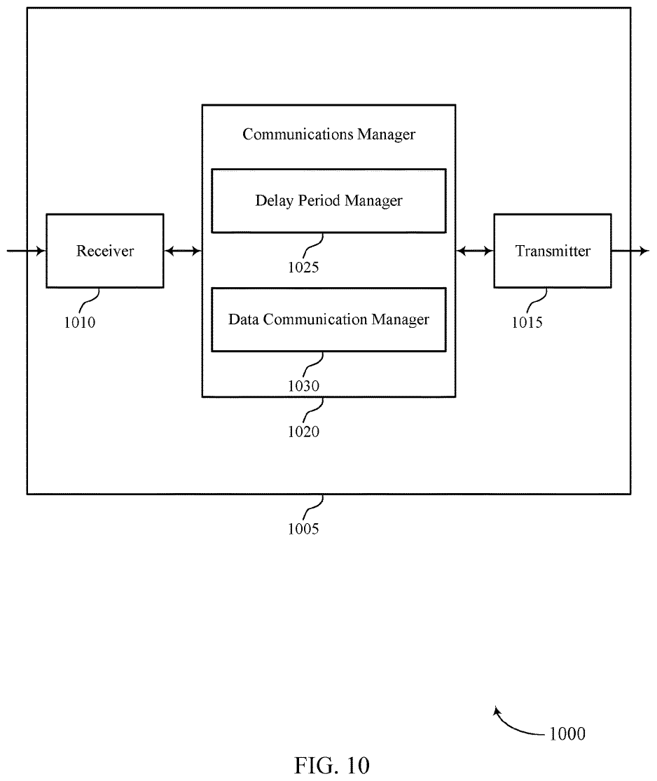

FIG. 10 shows a block diagram 1000 of a device 1005 that supports conditional communication times for EH-capable devices in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of conditional communication times for EH-capable devices as described herein. For example, the communications manager 1020 may include a delay period manager 1025 a data communication manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The delay period manager 1025 is capable of, configured to, or operable to support a means for receiving, from an EH-capable UE, control information indicating a threshold delay period between communications involving the EH-capable UE. The data communication manager 1030 is capable of, configured to, or operable to support a means for performing, with the EH-capable UE, a first communication of data. The data communication manager 1030 is capable of, configured to, or operable to support a means for performing, with the EH-capable UE, a second communication of data based on a time period between the first communication and the second communication satisfying the threshold delay period.

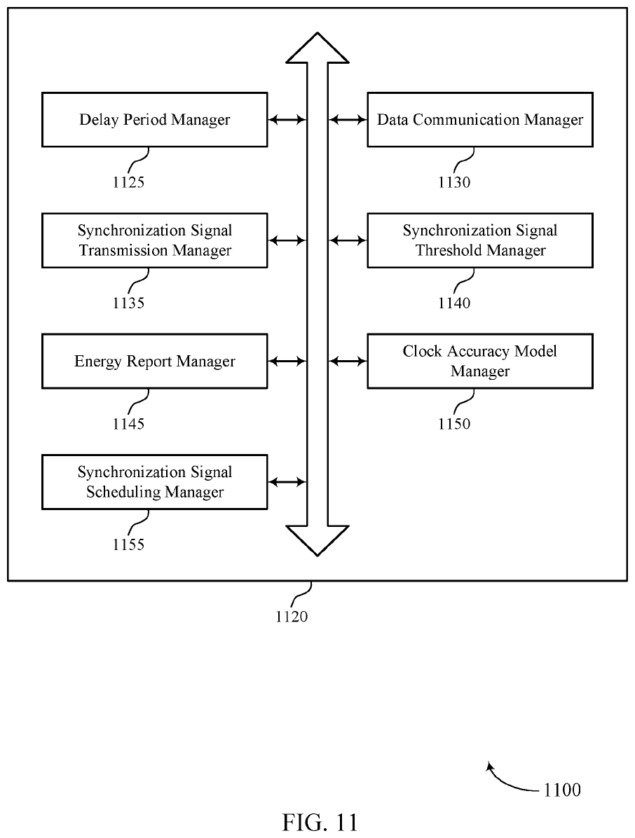

FIG. 11 shows a block diagram 1100 of a communications manager 1120 that supports conditional communication times for EH-capable devices in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of conditional communication times for EH-capable devices as described herein. For example, the communications manager 1120 may include a delay period manager 1125, a data communication manager 1130, a synchronization signal transmission manager 1135, a synchronization signal threshold manager 1140, an energy report manager 1145, a clock accuracy model manager 1150, a synchronization signal scheduling manager 1155, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The delay period manager 1125 is capable of, configured to, or operable to support a means for receiving, from an EH-capable UE, control information indicating a threshold delay period between communications involving the EH-capable UE. The data communication manager 1130 is capable of, configured to, or operable to support a means for performing, with the EH-capable UE, a first communication of data. In some examples, the data communication manager 1130 is capable of, configured to, or operable to support a means for performing, with the EH-capable UE, a second communication of data based on a time period between the first communication and the second communication satisfying the threshold delay period.

In some examples, the synchronization signal transmission manager 1135 is capable of, configured to, or operable to support a means for transmitting a quantity of synchronization signals between performance of the first communication and the second communication, where the threshold delay period is based on a threshold quantity of synchronization signals, and where the quantity of synchronization signals satisfies the threshold quantity of synchronization signals.

In some examples, the threshold quantity of synchronization signals is based on an operating bandwidth for the EH-capable UE, a signal type of the first communication, a signal type of the second communication, a transmission power of the first communication, a transmission power of the second communication, a device class of the EH-capable UE, or a combination thereof.

In some examples, to support receiving the control information indicating the threshold delay period, the clock accuracy model manager 1150 is capable of, configured to, or operable to support a means for receiving an indication of a clock accuracy model for the EH-capable UE.

In some examples, to support performing the first communication, the data communication manager 1130 is capable of, configured to, or operable to support a means for transmitting the first communication, and where performing the second communication includes one of receiving or transmitting the second communication.

In some examples, the synchronization signal scheduling manager 1155 is capable of, configured to, or operable to support a means for transmitting, to the EH-capable UE, scheduling information for a set of synchronization signals, where the set of synchronization signals includes the quantity of synchronization signals, and where the threshold delay period is based on the scheduling information.

In some examples, to support receiving the control information, the synchronization signal threshold manager 1140 is capable of, configured to, or operable to support a means for receiving an indication of a threshold quantity of synchronization signals between the communications involving the EH-capable UE in addition to the threshold delay period, where performance of the second communication is based on transmission of a quantity of synchronization signals between performance of the first communication and the second communication that satisfies the threshold quantity of synchronization signals.

In some examples, to support performing the first communication, the data communication manager 1130 is capable of, configured to, or operable to support a means for receiving the first communication, and where performing the second communication includes one of receiving or transmitting the second communication.

In some examples, to support receiving the control information indicating the threshold delay period, the energy report manager 1145 is capable of, configured to, or operable to support a means for receiving an energy report for the EH-capable UE, an indication of a device class of the EH-capable UE, or a combination thereof.

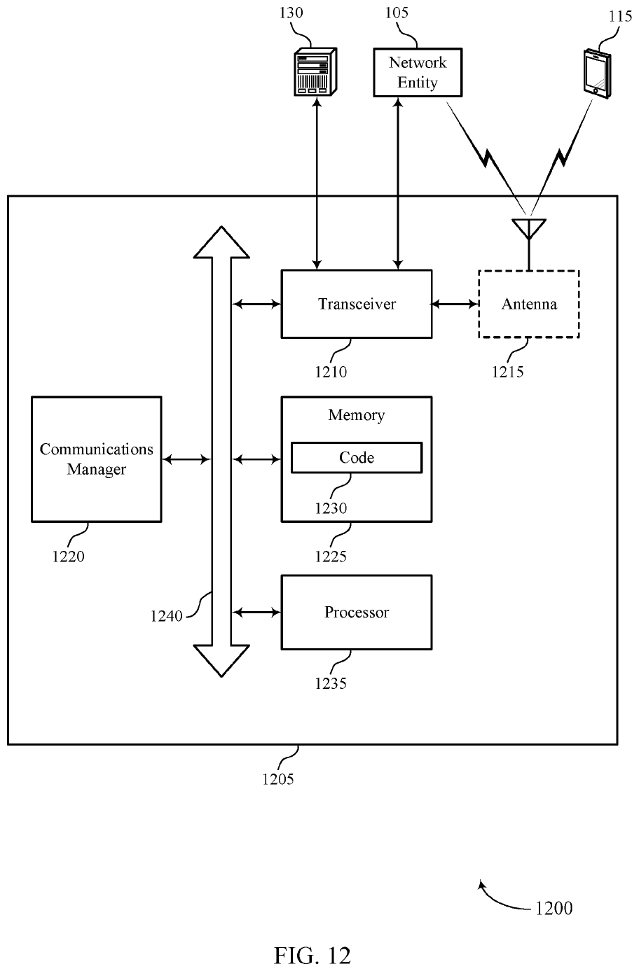

FIG. 12 shows a diagram of a system 1200 including a device 1205 that supports conditional communication times for EH-capable devices in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting conditional communication times for EH-capable devices). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some implementations, the at least one processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the at least one processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving, from an EH-capable UE, control information indicating a threshold delay period between communications involving the EH-capable UE. The communications manager 1220 is capable of, configured to, or operable to support a means for performing, with the EH-capable UE, a first communication of data. The communications manager 1220 is capable of, configured to, or operable to support a means for performing, with the EH-capable UE, a second communication of data based on a time period between the first communication and the second communication satisfying the threshold delay period.

By including or configuring the communications manager 1220 in accordance with examples as described herein, the device 1205 may support techniques for improved communication reliability, reduced power consumption, more efficient utilization of communication resources and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of conditional communication times for EH-capable devices as described herein, or the at least one processor 1235 and the at least one memory 1225 may be otherwise configured to, individually or collectively, perform or support such operations.

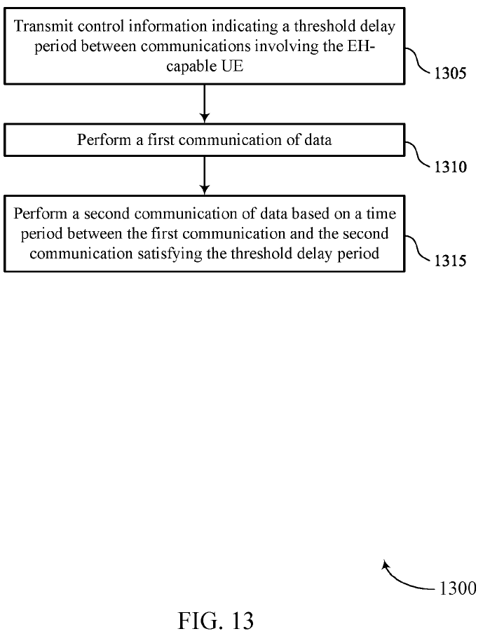

FIG. 13 shows a flowchart illustrating a method 1300 that supports conditional communication times for EH-capable devices in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting control information indicating a threshold delay period between communications involving the EH-capable UE. The operations of block 1305 may be performed in accordance with examples as disclosed herein. In some examples, aspects of the operations of 1305 may be performed by a delay period manager 725 as described with reference to FIG. 7.

At 1310, the method may include performing a first communication of data. The operations of block 1310 may be performed in accordance with examples as disclosed herein. In some examples, aspects of the operations of 1310 may be performed by a data communication manager 730 as described with reference to FIG. 7.

At 1315, the method may include performing a second communication of data based on a time period between the first communication and the second communication satisfying the threshold delay period. The operations of block 1315 may be performed in accordance with examples as disclosed herein. In some examples, aspects of the operations of 1315 may be performed by a data communication manager 730 as described with reference to FIG. 7.

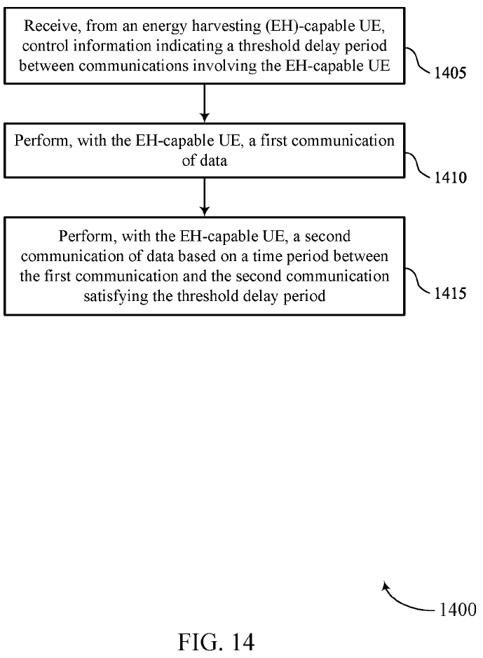

FIG. 14 shows a flowchart illustrating a method 1400 that supports conditional communication times for EH-capable devices in accordance with aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include receiving, from an EH-capable UE, control information indicating a threshold delay period between communications involving the EH-capable UE. The operations of block 1405 may be performed in accordance with examples as disclosed herein. In some examples, aspects of the operations of 1405 may be performed by a delay period manager 1125 as described with reference to FIG. 11.

At 1410, the method may include performing, with the EH-capable UE, a first communication of data. The operations of block 1410 may be performed in accordance with examples as disclosed herein. In some examples, aspects of the operations of 1410 may be performed by a data communication manager 1130 as described with reference to FIG. 11.

At 1415, the method may include performing, with the EH-capable UE, a second communication of data based on a time period between the first communication and the second communication satisfying the threshold delay period. The operations of block 1415 may be performed in accordance with examples as disclosed herein. In some examples, aspects of the operations of 1415 may be performed by a data communication manager 1130 as described with reference to FIG. 11.

The following provides an overview of aspects of the present disclosure:

Aspect 1: A method for wireless communications at an EH-capable UE, comprising: transmitting control information indicating a threshold delay period between communications involving the EH-capable UE; performing a first communication of data; and performing a second communication of data based at least in part on a time period between the first communication and the second communication satisfying the threshold delay period.

Aspect 2: The method of aspect 1, further comprising: receiving a quantity of synchronization signals between performance of the first communication and the second communication, wherein the threshold delay period is based at least in part on reception of a threshold quantity of synchronization signals, and wherein the quantity of synchronization signals satisfies the threshold quantity of synchronization signals.

Aspect 3: The method of aspect 2, further comprising: identifying the threshold quantity of synchronization signals based at least in part on an operating bandwidth for the EH-capable UE, a signal type of the first communication, a signal type of the second communication, a transmission power of the first communication, a transmission power of the second communication, a device class of the EH-capable UE, or a combination thereof.

Aspect 4: The method of any of aspects 2 through 3, wherein transmitting the control information indicating the threshold delay period comprises: transmitting an indication of a clock accuracy model for the EH-capable UE.

Aspect 5: The method of any of aspects 2 through 4, wherein performing the first communication comprises: receiving the first communication, wherein performing the second communication comprises one of receiving or transmitting the second communication.

Aspect 6: The method of any of aspects 2 through 5, further comprising: receiving scheduling information for a set of synchronization signals, wherein the set of synchronization signals comprises the quantity of synchronization signals, and wherein the threshold delay period is based at least in part on the scheduling information.

Aspect 7: The method of any of aspects 1 through 6, wherein transmitting the control information comprises: transmitting an indication of a threshold quantity of synchronization signals between the communications involving the EH-capable UE in addition to indicating the threshold delay period, wherein performance of the second communication is based at least in part on reception of a quantity of synchronization signals between performance of the first communication and the second communication that satisfies the threshold quantity of synchronization signals.

Aspect 8: The method of any of aspects 1 through 4 or 6 through 7, wherein performing the first communication comprises: transmitting the first communication, and wherein performing the second communication comprises one of receiving or transmitting the second communication.

Aspect 9: The method of any of aspects 1 through 8, wherein transmitting the control information indicating the threshold delay period comprises: transmitting an energy report for the EH-capable UE, an indication of a device class of the EH-capable UE, or a combination thereof.

Aspect 10: A method for wireless communications at a network entity, comprising: receiving, from an EH-capable UE, control information indicating a threshold delay period between communications involving the EH-capable UE; performing, with the EH-capable UE, a first communication of data; and performing, with the EH-capable UE, a second communication of data based at least in part on a time period between the first communication and the second communication satisfying the threshold delay period.

Aspect 11: The method of aspect 10, further comprising: transmitting a quantity of synchronization signals between performance of the first communication and the second communication, wherein the threshold delay period is based at least in part on a threshold quantity of synchronization signals, and wherein the quantity of synchronization signals satisfies the threshold quantity of synchronization signals.

Aspect 12: The method of aspect 11, wherein the threshold quantity of synchronization signals is based at least in part on an operating bandwidth for the EH-capable UE, a signal type of the first communication, a signal type of the second communication, a transmission power of the first communication, a transmission power of the second communication, a device class of the EH-capable UE, or a combination thereof.

Aspect 13: The method of any of aspects 11 through 12, wherein receiving the control information indicating the threshold delay period comprises: receiving an indication of a clock accuracy model for the EH-capable UE.

Aspect 14: The method of any of aspects 11 through 13, wherein performing the first communication comprises: transmitting the first communication, and wherein performing the second communication comprises one of receiving or transmitting the second communication.

Aspect 15: The method of any of aspects 11 through 14, further comprising: transmitting, to the EH-capable UE, scheduling information for a set of synchronization signals, wherein the set of synchronization signals comprises the quantity of synchronization signals, and wherein the threshold delay period is based at least in part on the scheduling information.

Aspect 16: The method of any of aspects 10 through 15, wherein receiving the control information comprises: receiving an indication of a threshold quantity of synchronization signals between the communications involving the EH-capable UE in addition to the threshold delay period, wherein performance of the second communication is based at least in part on transmission of a quantity of synchronization signals between performance of the first communication and the second communication that satisfies the threshold quantity of synchronization signals.

Aspect 17: The method of any of aspects 10 through 13 or 15 through 16, wherein performing the first communication comprises: receiving the first communication, and wherein performing the second communication comprises one of receiving or transmitting the second communication.

Aspect 18: The method of any of aspects 10 through 17, wherein receiving the control information indicating the threshold delay period comprises: receiving an energy report for the EH-capable UE, an indication of a device class of the EH-capable UE, or a combination thereof.

Aspect 19: An EH-capable UE for wireless communications, comprising one or more memories storing processor-executable code, and one or more processors coupled with the one or more memories and individually or collectively operable to execute the code to cause the EH-capable UE to perform a method of any of aspects 1 through 9.

Aspect 20: An EH-capable UE for wireless communications, comprising at least one means for performing a method of any of aspects 1 through 9.

Aspect 21: A non-transitory computer-readable medium storing code for wireless communications, the code comprising instructions executable by a processor to perform a method of any of aspects 1 through 9.

Aspect 22: A network entity for wireless communications, comprising one or more memories storing processor-executable code, and one or more processors coupled with the one or more memories and individually or collectively operable to execute the code to cause the network entity to perform a method of any of aspects 10 through 18.

Aspect 23: A network entity for wireless communications, comprising at least one means for performing a method of any of aspects 10 through 18.

Aspect 24: A non-transitory computer-readable medium storing code for wireless communications, the code comprising instructions executable by a processor to perform a method of any of aspects 10 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An energy harvesting (EH)-capable user equipment (UE), comprising:
one or more memories storing processor-executable code; and
one or more processors coupled with the one or more memories and individually or collectively operable to execute the code to cause the EH-capable UE to:
transmit control information indicating a threshold delay period between communications involving the EH-capable UE;
perform a first communication of data; and
perform a second communication of data based at least in part on a time period between the first communication and the second communication satisfying the threshold delay period.

2. The EH-capable UE of claim 1, wherein the one or more processors are individually or collectively further operable to execute the code to cause the EH-capable UE to:
receive a quantity of synchronization signals between performance of the first communication and the second communication, wherein the threshold delay period is based at least in part on reception of a threshold quantity of synchronization signals, and wherein the quantity of synchronization signals satisfies the threshold quantity of synchronization signals.

3. The EH-capable UE of claim 2, wherein the one or more processors are individually or collectively further operable to execute the code to cause the EH-capable UE to:
identify the threshold quantity of synchronization signals based at least in part on an operating bandwidth for the EH-capable UE, a signal type of the first communication, a signal type of the second communication, a transmission power of the first communication, a transmission power of the second communication, a device class of the EH-capable UE, or a combination thereof.

4. The EH-capable UE of claim 2, wherein, to transmit the control information indicating the threshold delay period, the one or more processors are individually or collectively operable to execute the code to cause the EH-capable UE to:
transmit an indication of a clock accuracy model for the EH-capable UE.

5. The EH-capable UE of claim 2, wherein, to perform the first communication, the one or more processors are individually or collectively operable to execute the code to cause the EH-capable UE to:
receive the first communication, wherein performing the second communication comprises one of receiving or transmitting the second communication.

6. The EH-capable UE of claim 2, wherein the one or more processors are individually or collectively further operable to execute the code to cause the EH-capable UE to:
receive scheduling information for a set of synchronization signals, wherein the set of synchronization signals comprises the quantity of synchronization signals, and wherein the threshold delay period is based at least in part on the scheduling information.

7. The EH-capable UE of claim 1, wherein, to transmit the control information, the one or more processors are individually or collectively operable to execute the code to cause the EH-capable UE to:
transmit an indication of a threshold quantity of synchronization signals between the communications involving the EH-capable UE in addition to indicating the threshold delay period, wherein performance of the second communication is based at least in part on reception of a quantity of synchronization signals between performance of the first communication and the second communication that satisfies the threshold quantity of synchronization signals.

8. The EH-capable UE of claim 1, wherein, to perform the first communication, the one or more processors are individually or collectively operable to execute the code to cause the EH-capable UE to:
transmit the first communication, and wherein performing the second communication comprises one of receiving or transmitting the second communication.

9. The EH-capable UE of claim 1, wherein, to transmit the control information indicating the threshold delay period, the one or more processors are individually or collectively operable to execute the code to cause the EH-capable UE to:
transmit an energy report for the EH-capable UE, an indication of a device class of the EH-capable UE, or a combination thereof.

10. A network entity, comprising:
one or more memories storing processor-executable code; and
one or more processors coupled with the one or more memories and individually or collectively operable to execute the code to cause the network entity to:
receive, from an energy harvesting (EH)-capable user equipment (UE), control information indicating a threshold delay period between communications involving the EH-capable UE;
perform, with the EH-capable UE, a first communication of data; and
perform, with the EH-capable UE, a second communication of data based at least in part on a time period between the first communication and the second communication satisfying the threshold delay period.

11. The network entity of claim 10, wherein the one or more processors are individually or collectively further operable to execute the code to cause the network entity to:
transmit a quantity of synchronization signals between performance of the first communication and the second communication, wherein the threshold delay period is based at least in part on a threshold quantity of synchronization signals, and wherein the quantity of synchronization signals satisfies the threshold quantity of synchronization signals.

12. The network entity of claim 11, wherein the threshold quantity of synchronization signals is based at least in part on an operating bandwidth for the EH-capable UE, a signal type of the first communication, a signal type of the second communication, a transmission power of the first communication, a transmission power of the second communication, a device class of the EH-capable UE, or a combination thereof.

13. The network entity of claim 11, wherein, to receive the control information indicating the threshold delay period, the one or more processors are individually or collectively operable to execute the code to cause the network entity to:
receive an indication of a clock accuracy model for the EH-capable UE.

14. The network entity of claim 11, wherein, to perform the first communication, the one or more processors are individually or collectively operable to execute the code to cause the network entity to:
transmit the first communication, and wherein performing the second communication comprises one of receiving or transmitting the second communication.

15. The network entity of claim 11, wherein the one or more processors are individually or collectively further operable to execute the code to cause the network entity to:
transmit, to the EH-capable UE, scheduling information for a set of synchronization signals, wherein the set of synchronization signals comprises the quantity of synchronization signals, and wherein the threshold delay period is based at least in part on the scheduling information.

16. The network entity of claim 10, wherein, to receive the control information, the one or more processors are individually or collectively operable to execute the code to cause the network entity to:
receive an indication of a threshold quantity of synchronization signals between the communications involving the EH-capable UE in addition to the threshold delay period, wherein performance of the second communication is based at least in part on transmission of a quantity of synchronization signals between performance of the first communication and the second communication that satisfies the threshold quantity of synchronization signals.

17. The network entity of claim 10, wherein, to perform the first communication, the one or more processors are individually or collectively operable to execute the code to cause the network entity to:
receive the first communication, and wherein performing the second communication comprises one of receiving or transmitting the second communication.

18. The network entity of claim 10, wherein, to receive the control information indicating the threshold delay period, the one or more processors are individually or collectively operable to execute the code to cause the network entity to:
receive an energy report for the EH-capable UE, an indication of a device class of the EH-capable UE, or a combination thereof.

19. A method for wireless communications at an energy harvesting (EH)-capable user equipment (UE), comprising:
transmitting control information indicating a threshold delay period between communications involving the EH-capable UE;
performing a first communication of data; and
performing a second communication of data based at least in part on a time period between the first communication and the second communication satisfying the threshold delay period.

20. The method of claim 19, further comprising:
receiving a quantity of synchronization signals between performance of the first communication and the second communication, wherein the threshold delay period is based at least in part on reception of a threshold quantity of synchronization signals, and wherein the quantity of synchronization signals satisfies the threshold quantity of synchronization signals.
